(19) United States
(12) Patent Application Publication
(10) Pub. No.: US 2008/0121444 A1
(43) Pub. Date: May 29, 2008

(54) Straddle carrier having a low-emission and low-maintenance turbine drive

(75) Inventor: Reinhard Bauer, Remlingen (DE)

Correspondence Address: COLLARD & ROE, P.C., 1077 NORTHERN BOULEVARD, ROSLYN, NY, 11576, US

(73) Assignee: Noell Mobile Systems GmbH

(21) Appl. No.: 11/986,696

(22) Filed: Nov. 26, 2007

(30) Foreign Application Priority Data
Nov. 25, 2006 (DE) 10 2006 055 749.2

(51) Int. Cl. B60L 11/02; B60L 11/12

(52) U.S. Cl. 180/65.1; 307/31; 290/50

(57) ABSTRACT

A straddle carrier having an electric drive system, consisting of a lower and an upper frame, which are connected with one another by means of supports. A lifting mechanism with hoists is disposed on the upper frame, and the lower frame consists of chassis carriers having electrically driven wheels, and a power generation unit that feeds its generated electric power into a direct voltage intermediate circuit, to which current inverters for supplying the travel, lifting, and auxiliary motors are connected. The power generation unit represents a micro gas turbine having an attached power generator, the power of which is passed to the travel, lifting, and auxiliary motors. The straddle carrier can be produced at low weight and maintained under advantageous conditions. Furthermore, the straddle carrier can be operated under environmentally friendly conditions.

### CROSS-REFERENCE TO RELATED APPLICATIONS

This application claims priority under 35 U.S.C. §119 of German Patent Application No. 10 2006 055 749.2, filed on Nov. 25, 2006.

### BACKGROUND OF THE INVENTION

1. Field of the Invention

The invention relates to a straddle carrier, also known as a portal lift truck, having an electric drive system. The straddle carrier according to the invention can be used worldwide in ocean harbors, container transport terminals, for transporting and stacking containers, and is particularly well suited where diesel-operated vehicles cannot easily be operated, due to their noise, exhaust gases, lubricant oil, and need for regular maintenance.

2. The Prior Art

Diesel-electric drive systems for such straddle carriers are known. In general, they consist of a diesel engine having a generator for generating electric power, a direct current intermediate circuit, and several current inverters that can be regulated and are connected to it, for supplying rotary current to the electric chassis, lifting mechanism, and auxiliary motors.

Such a drive system is shown, for example, by DE 200 01 113 U1. There, a vehicle having an internal combustion engine and a generator excited from the outside is disclosed, which generator feeds into the direct voltage intermediate circuit by way of an uncontrolled rectifier. For technical reasons, the internal combustion engine can only be a lifting piston motor, as will be explained in the following.

In German Patent NO. DE 200 01 113 U1, an internal combustion engine having a generator is proposed for power generation, whereby a control and regulation unit regulates the speed of rotation of the internal combustion engine in accordance with the power need of the vehicle. Furthermore, an output voltage regulator regulates the excitation of the generator so that the intermediate circuit voltage can be kept in a predetermined, permissible range. Thus, the generator is excited from the outside, not permanently, since permanent excitation cannot be regulated. In this connection, the internal combustion engine can only be an engine that runs at low speeds of rotation, in other words a diesel or gasoline engine, for example, since the technical effort for a generator excited from the outside would be far too great on a vehicle, in the case of a very high-speed internal combustion engine such as a gas turbine, at almost 100,000 rpm. A heavy and large step-down transmission would be necessary, since at these high speeds of rotation, the centripetal forces on the rotor coils of a generator excited from the outside could no longer be managed.

An electric drive system with an internal combustion engine is also proposed for heavy vehicles in German Patent No. DE 198 04 204 C2, which furthermore also contains a battery for the purpose of utilizing braking power and making peak power available, along with a detection and control system for control of the power output of the internal combustion engine as needed.

German Patent No. DE 197 45 094 A1 also shows a production hybrid vehicle with an internal combustion engine/generator unit, power management, and a battery.

In German Patent No. DE 103 46 796 A1, an energy storage unit of ultra-capacitors is proposed in place of a battery, which has much better properties for vehicle applications than a battery, e.g. greater power density, freedom from maintenance, longer useful lifetime.

Furthermore, a straddle carrier with hybrid drive is proposed in German Patent No. DE 10 2004 010 988 A1, which obtains its electric power from three sources, in accordance with the usual load situations of a portal truck: a relatively small internal combustion engine with a generator as the primary power source for producing average permanent power, a battery for travel at high speeds, and ultra-capacitors for short-term power peaks during lifting/lowering and braking/acceleration. In this connection, the internal combustion engine can be configured significantly smaller and lighter than usual, and the batteries have a longer useful lifetime. The size and weight of the two energy storage units can be kept within reasonable limits.

However, all of these previously known drive systems have an internal combustion engine as the primary power source, and therefore have numerous different disadvantages.

For example, the diesel engine has to be maintained relatively frequently: engine oil and oil filters must be replaced regularly, coolant level and anti-freeze must be checked, the valve play must be checked and adjusted, and much more. The larger amounts of used oil of a vehicle fleet must be disposed of in an environmentally friendly manner. Finally, the diesel engine must be completely replaced/reworked after approximately 10-15 thousand hours of operation, so that several new diesel engines might be needed for a straddle carrier, which usually has a useful lifetime of more than 30,000 hours of operation.

Diesel engines also emit harmful exhaust gases in amounts that will be tolerated less and less by legislators and society in the future. The exhaust gas standards are being constantly tightened for straddle carriers, as well, so that ever greater technical effort is required for purification of the exhaust gases of their diesel engines.

We should not forget the noise of a diesel engine, which must be damped with large, heavy, and expensive noise protection hoods on straddle carriers, in order to adhere to the noise protection regulations, particularly in harbor regions that lie close to populated areas.

Furthermore, it is a disadvantage of previous straddle carriers that the diesel engine cause vibrations that are transferred to the vehicle and have already frequently resulted in vibration-caused damage, particularly to the electronics of the frequency current inverters and the generator, so that complicated and expensive repairs were necessary.

An electric hybrid drive for a vehicle is described in U.S. Pat. No. 6,683,389, in which a turbogenerator is also mentioned. It is not evident from the document that the solution is also suitable for vehicles and lift vehicles, such as a straddle carrier, in which the most varied load demands of travel and lifting drives can occur at the same time and superimposed on one another, and what adaptations are necessary to operate a straddle carrier in this manner.

### SUMMARY OF THE INVENTION

It is therefore an object of the invention to eliminate the disadvantages of the known prior art, and to develop a straddle carrier that has a drive system that makes do with clearly less maintenance and replacement, causes fewer harmful exhaust gases and noise, is gentle on the sensitive electronics because of its quiet, vibration-free operation, and keeps the expenditure for this within reasonable limits.

This task is accomplished by means of a straddle carrier having an electric drive system, consisting of a lower and an upper frame, which are connected with one another by means of supports. A lifting mechanism with hoists is disposed on the upper frame, and the lower frame consists of chassis carriers having electrically driven wheels and a power generation unit that feeds its generated electric power into a direct voltage intermediate circuit, to which current inverters for supplying the travel, lifting, and auxiliary motors are connected. The power generation unit represents a micro gas turbine having an attached power generator, the power of which is passed to the travel, lifting, and auxiliary motors, and a separate regulator disposed on the micro gas turbine, which regulates the operating variables of power, speed of rotation, and temperature of the turbine individually, together, or in combination, to achieve reference values that can be predetermined. There are current inverters that can be regulated disposed ahead of the chassis, auxiliary, and lifting mechanism motors and an electronic power management of the straddle carrier is disposed on the regulator for the power generation unit, which control coordinates the power and voltage of the power generation unit and drive motors with one another. Appropriate reference values are provided to the regulator of the power generation unit and the current inverters of the drive motors, which can be regulated, by the power management. The most different load demands of travel and lifting mechanism drives occur superimposed on one another. There is an electric power storage unit disposed on a bus bar of the intermediate circuit, directly or indirectly, which unit evens out load variations and saves braking and lowering power.

The invention provides that in place of a power unit with a diesel engine, a micro turbine with a power generator is integrated into the drive train of the straddle carrier. The integration relates both to the power electronics and to the control and regulation electronics, and the technical effort for this remains low.

Such micro turbines or micro gas turbines are based on the technology of exhaust gas turbochargers and have been developed further, in the meantime, in a direction that allowed them to be of interest for use on electric or hybrid vehicles.

A micro turbine has an unstable working point. The power generated by the turbine and the power taken off from the generator must agree with one another, so that the turbine does not stall during load variations (flow break-down, stall), or go into dangerous excessive speeds of rotation. It therefore needs a regulation system that precisely coordinates the power taken off, the speed of rotation, the turbine inlet temperature, and the fuel feed with each other.

Such regulation is possible in that the speed of rotation and the inlet temperature of the turbine are detected by way of sensors and passed to an electronic control device, the microprocessor, which then controls a fuel regulation valve in order to keep the turbine in a narrow optimal speed of rotation and temperature range by means of setting the amount of fuel. In this connection, the same electric power always has to be taken off from the turbine generator, as well, and for this purpose, the regulation system controls power electronics, e.g. an IGBT current inverter. A power storage unit such as a rechargeable battery must therefore balance out the load variations of the electric power given off for consumption, as compared with the constantly produced turbine power.

A further development of this regulation system consists in no longer keeping the generated turbine power constant, but rather regulating it to the required load when load variations occur, by means of adjusting the speed of rotation, whereby nevertheless, the optimal turbine inlet temperature is maintained. This has the advantage that even in partial load operation, only slight losses in the degree of effectiveness occur. A power storage unit, e.g. a buffer battery, takes over the electric load difference only part of the time, if load variations occur, until the turbine power has been adjusted. If the required turbine power is to be increased by increasing the speed of rotation, for instance, the regulator temporarily decreases the electric power output of the generator by controlling a current inverter, in other words relieves the stress on the turbine, so that it can run up to the new speed of rotation at a constant temperature, and in turn increases the power output of the buffer battery, until the new speed of rotation and power have been reached. Then, the entire power needed is taken from the generator once again.

From this, it is evident that such a micro turbine power unit can only function in a usable manner together with the installed power electronics, a digital regulation system, and a storage battery. Without these electronics, the generator current that is generated, which has a frequency of over 1600 Hertz, could not supply any of the usual consumers, and the turbine could not be regulated in stable manner. Only power and regulation electronics, together with the battery, make it possible not to stall the turbine in case of load variations of the electric power that is taken off, or to accelerate it to dangerously high speeds of rotation.

However, if one were to simply build such micro turbine units according to the disclosed prior art onto a straddle carrier, many electronic components would unnecessarily be present multiple times. For example, the power generation units as disclosed in the aforementioned documents and designed for feeding into a network or as emergency power units, already have an internal direct current intermediate circuit with a subsequent current inverter, in order to give off 50 Hz alternating current from the 1600 Hz rotary current of the generator. But since the straddle carrier also has its own direct current intermediate circuit, an additional current inverter, which would actually be superfluous, would have to be installed, in order to rectify the 50 Hz alternating current produced by the micro turbine unit once again, and then feed it into the direct current intermediate circuit of the straddle carrier. This effort and expense is unjustifiable and would cause unnecessary conversion losses.

Furthermore, the micro turbine requires another current inverter for starting with a battery. In this connection, the generator is operated with a motor.

The micro turbine must be integrated into the otherwise present electric drive system of the vehicles, which has proven itself, with the least possible technical effort. In particular, the placement and wiring of the power electronics such as current inverters, rectifiers, DC/DC converters, must be configured in such a manner that one can make do with the least power electronics possible.

Furthermore, a digital regulator must be disposed in the micro turbine, which regulates and adjusts the turbine power that is generated when load variations of the consumers occur. However, this regulator is not suitable for balancing out the extreme load demands of the straddle carrier by itself, for example if the driver demands high performance from the chassis and the lifting mechanism at the same time, which exceeds the maximal turbine power at the current working point, in total. For this reason, a power management system specially designed for straddle carriers is also needed, in other words, a separate electronic power flow control, which coordinates the power generated by the turbine and the power used up for drive of the straddle carrier with one another. The same holds true analogously for the voltage that is fed in. Since the generator voltage depends on the turbine speed of rotation, because of the permanent excitation, but the intermediate circuit voltage must always be slightly higher than what the travel, lifting, and auxiliary motors of the vehicle need at their current speed of rotation, the electronic control must also influence the intermediate circuit voltage. The power management control must therefore react specifically to the requirements of a straddle carrier, in which the most different load demands of travel and lifting drives occur superimposed on one another, at the same time.

Finally, it is advantageous to supply the auxiliary drives, such as hydraulic pumps for steering, brakes, and spreader, the alternator for charging the batteries and supplying the on-board network, for example a 24V DC network, and the air conditioning of the driver's cabin, which were previously driven directly and mechanically by a diesel engine, with power from the micro turbine.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

FIG. 1 shows a configuration of the electric drive train of a straddle carrier or a portal lift truck, having a micro turbine drive; and

FIG. 2 shows a perspective view of the straddle carrier according to the invention.

### DETAILED DESCRIPTION OF THE PREFERRED EMBODIMENT

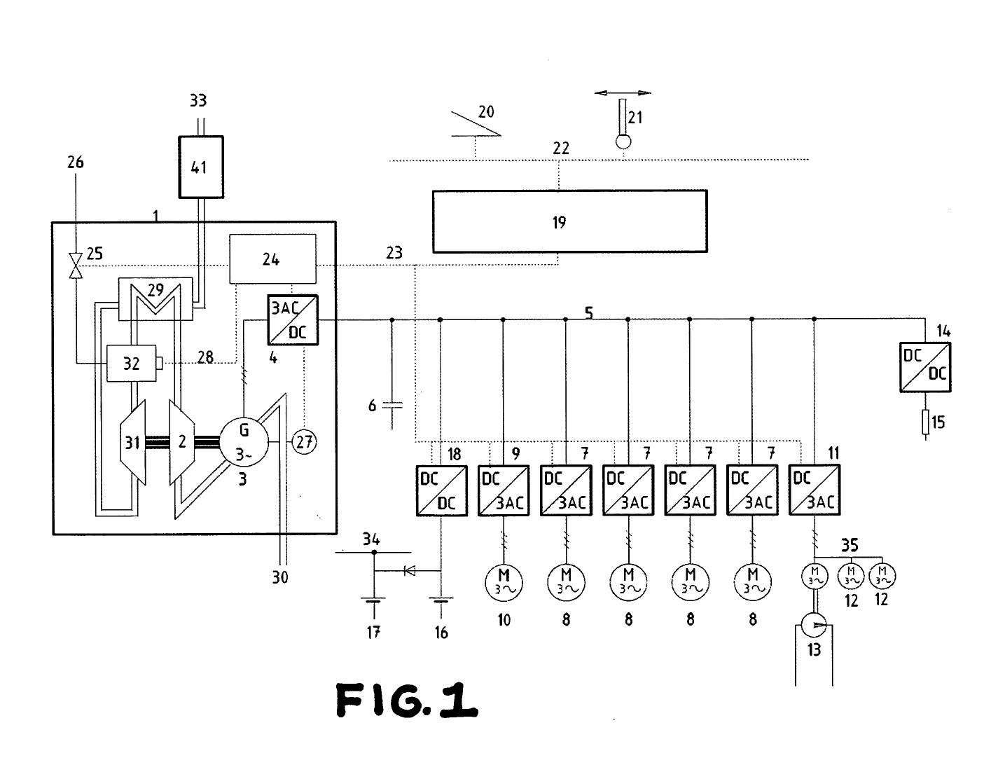

As shown in FIG. 1, the medium-frequency rotary current from generator 3 of micro turbine 2 is fed directly into a direct current intermediate circuit 5 of the straddle carrier, by way of a two-quadrant current inverter 4 that can be pulse-width-modulated and regulated. Current inverters 7, 9, 11 for chassis motors 8, lifting mechanism motor 10, and auxiliary motors 12 are connected directly with it, and brake resistors 15 are connected by way of brake choppers 14. The two batteries (a starter battery 16, and a battery 17 for the 24V DC on-board network, to supply the electronics and the lighting, are also connected with direct current intermediate circuit 5, by way of a DC/DC converter 18 (high/low regulator).

In addition to the usual auxiliary motors for the cooling pumps of the travel drives, the fan of the lifting mechanism drive, and other smaller motors and consumers, pump motor 13 of a small hydraulic station, which generates the hydraulic pressure for steering, braking, and the spreader, is also connected with current inverter 11 that generates rotary current for the 50 Hz on-board network (3AC 400V) 35 and auxiliary drives 12. In the case of a hydraulic-free straddle carrier with electric spreader, electromagnetic brakes, and purely electric steering, this hydraulic station can be eliminated. In the case of many commercially available, compact micro turbine power generation units, a current inverter for 3AC 400V 50 Hz for the purpose of network supply is already integrated. This can then supply the 50 Hz 3AC 400V on-board network and thus the auxiliary drives, in place of on-board network current inverter 11.

To start micro turbine 2, the voltage of starter battery 16 is set on high to the voltage level of direct voltage intermediate circuit 5, approximately 650 V DC, by the DC/DC converter 18, so that starter battery 16 feeds into intermediate circuit 5, but all of current inverters 7, 9, 11 are still closed, except for feed current inverter 4 of turbine generator 3. The latter feeds its frequency-variable rotary current, produced out of the direct current, onto generator 3 of micro turbine 2, and still turns it by motor. Starting from a certain speed of rotation, the fuel in combustion chamber 32 of turbine 2 can be ignited, and turbine 2 then continues to run independently, and can feed power into intermediate circuit 5 by way of feed current inverter 4, which now operates generator 3 as a generator. Current inverter 11 for the 50 Hz on-board network is now turned on, so that hydraulics, cooling, and ventilation can be supplied with power. Then, current inverters 7, 9 for the chassis and lifting mechanism can also be turned on, and the vehicle can start its work. At the same time, the batteries are charged by the micro turbine, out of intermediate circuit 5, by way of the DC/DC converter 18, which now functions as a low-set regulator.

Micro turbine 2 can be regulated, in terms of its power, by way of the speed of rotation. A digital regulator 2 integrated into the turbine detects the actual speed of rotation of the turbine and the turbine entry temperature by way of suitable sensors 27, 28, and controls its fuel throttle valve 25 accordingly. Electronic control 19 of the straddle carrier can digitally give the desired reference speed of rotation or reference power to the turbine regulator 24, by way of a field bus connection 23, for example a CAN bus, and thus control the power that is generated. The power adjustment by way of the speed of rotation also has the advantage that a good degree of effectiveness and low pollutant emissions are achieved even in the partial load range, since the thermodynamically important entry temperature into the turbine can be kept almost constantly at its optimal value, over broad partial load ranges.

However, the generator voltage also changes proportionally with the adjustment of the turbine speed of rotation, since generator 3 is excited by the permanent magnet and thus cannot have its own voltage regulation. However, since travel motors 8 and lifting motor 10 require specific minimum voltages on the direct current intermediate circuit 5 for specific speeds of rotation, power management system 19 must not only coordinate the power flow between turbine 2 and drives 8, 10, 12 with one another, but also take the required intermediate circuit voltage, in each instance, into consideration.

It is advantageous here to operate feed current inverter 4, which can be pulse-width-modulated, as a high-set regulator, and to regulate intermediate circuit voltage to a constant reference value by means of adjusting the pulse-width modulation. Such a voltage regulator can also be integrated into micro turbine regulation system 24.

The power management for the vehicle as a whole can take place in the following manner, for example: The driver of the vehicle sets the required torque for travel drives 8 with driving pedal 20, and sets the required speed of rotation for lifting mechanism drive 10 with a joystick 21. The driver's reference value setting takes place by way of first CAN bus 22 on electronic power management control 19 of the straddle carrier. This control calculates the required reference power from this, in that it multiplies the reference values according to the power formula P=2×3.14×n×M by the actual values of the individual drives, and adds them up. The reference power is passed to the turbine regulator 24 by way of a second CAN bus 23; regulator adjusts the speed of rotation of the turbine accordingly. The current actual power of power generation unit 1, which after all is different from the reference power until the turbine power has been adjusted, is detected by turbine regulator 24 by means of the integrated current measurement of feed current inverter 4, for example, and reported to the electronic power control 19 of the straddle carrier by way of the second CAN bus 23. The control then limits the torque reference values for chassis motors 8 and the speed of rotation reference value for lifting mechanism motor 10 until the turbine has adjusted its power. Even if the driver demands more power from the travel and lifting mechanisms, in total, than the turbine can provide at that moment, the power of the travel and lifting mechanisms are limited to the current actual power of the power generation unit.

In other variants of the embodiment, a larger electric power storage unit, such as a traction battery or also double-layer capacitors, can be connected to direct current intermediate circuit in place of small starter battery 16. In this way, the turbine power generation unit can be structured to be even smaller and lighter, since the load peaks are taken over by the power storage unit and the power generation unit only has to supply the average permanent power. Furthermore, the power storage unit can provided intermediate storage for lowering power of the lifting mechanism and braking power of the chassis, for later use, and thereby save fuel. For straddle carriers, it is particularly advantageous to use a combination of traction battery and double-layer capacitors as a power storage unit, since this increases the useful lifetime of the traction battery while limiting its weight and size, also keeps the expenditure for expensive double-layer capacitors within limits.

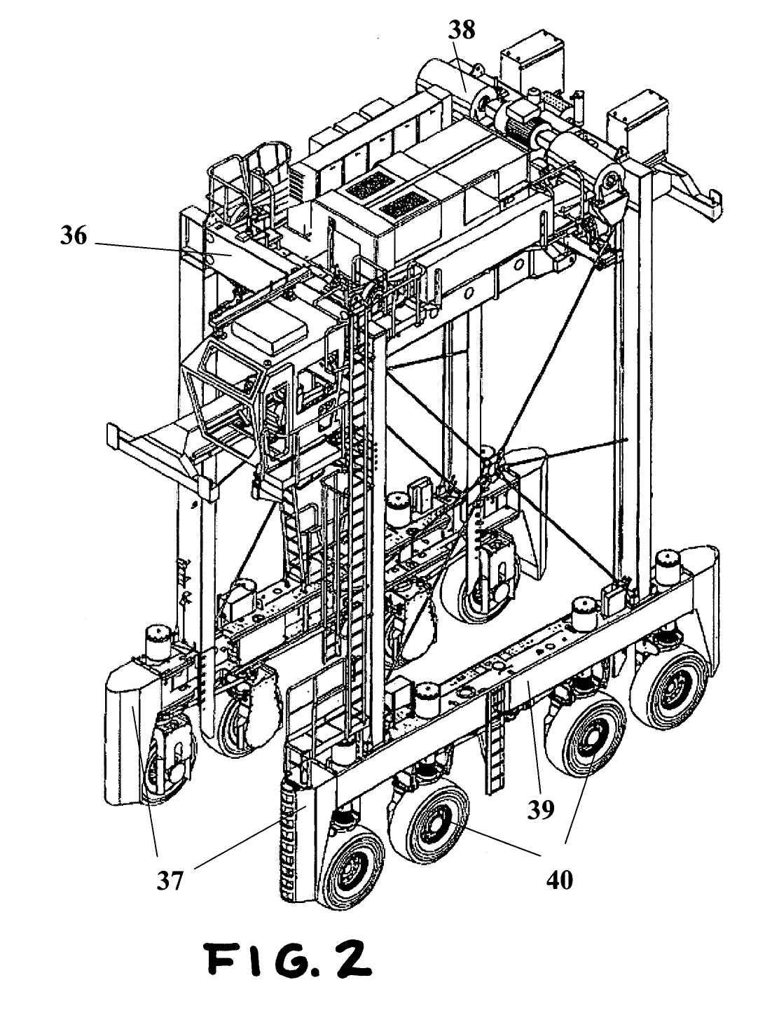

A complete view of the straddle carrier is shown in FIG. 2. The lift truck consists of an upper frame 36, a lower frame 37, a lifting mechanism with hoists 38, and chassis carriers 39. Chassis carriers 39 have electrically driven wheels 40. A heat exchanger 41 (shown in FIG. 1) is also on the truck, and connected with recuperator 29.

For the purpose of heating the driver's cabin, the micro turbine can be followed by an exhaust gas heat exchanger. This is often already integrated into commercially available micro turbine units. The straddle carrier according to the invention demonstrates the following advantages:

The power generation unit is smaller and lighter than a comparable diesel engine generator.

In contrast to a diesel engine, it does not have a lubrication system or liquid cooling, and therefore requires significantly less maintenance.

It produces much less noise and therefore does not require a large, heavy noise protection hood in order to adhere to noise protection regulations.

Also, it only emits small amounts of pollutants with the exhaust gases, and remains far below the prescribed exhaust gas limit values even without exhaust gas treatment.

Since it has only one movable part, which is furthermore air-mounted, it has only little wear. Its useful lifetime is therefore much greater than that of a diesel engine, so that a complete replacement during the useful lifetime of the straddle carrier is no longer necessary.

Its quiet, low-vibration running is gentle on the vehicle electronics, which are sensitive to vibrations, so that fewer failures and repairs are to be expected.

Accordingly, while only a few embodiments of the present invention have been shown and described, it is obvious that many changes and modifications may be made thereunto without departing from the spirit and scope of the invention.

### LIST OF REFERENCE SYMBOLS USED

1 power generation unit
2 micro turbine
3 generator
4 feed converter of the micro turbine (pulse-width-modulated, controllable in two quadrants)
5 bus bar of the direct current intermediate circuit of the straddle carrier
6 intermediate circuit capacitors
7 current inverter (can be regulated) for the travel motors
8 chassis motors
9 current inverter (can be regulated) for the lifting mechanism motor
10 lifting mechanism motor
11 current inverter (can be regulated) for the on-board network, for example a 3AC 400V on-board network of the auxiliary drives
12 auxiliary motors (hydraulic pumps, cooler pumps, fans, air conditioning units, heating systems, etc.)
13 hydraulic pump for steering, brakes, spreader
14 brake chopper (DC/DC converter, lowering mechanism)
15 brake resistor
16 starter battery, or traction battery or electric power storage unit comprising double-layer capacitors
17 battery for electronics and lighting, e.g. 24V DC-on-board network
18 charge/discharge regulator for rechargeable batteries (raising/lowering mechanism, DC/DC converter)
19 electronic control for the straddle carrier, with power flow control (power management)
20 driving pedal
21 joystick (master switch) for lifting mechanism
22 1st CAN bus (vehicle bus)
23 2nd CAN bus (drive bus)
24 regulator of the micro turbine unit
25 fuel regulating valve
26 fuel feed
27 speed of rotation sensor
28 temperature sensor
29 recuperator
30 air inlet for micro turbine unit with air cooling of generator
31 compressor wheel
32 combustion chamber
33 exhaust gases
34 bus bar of the on-board network for electronics and lighting (24V DC-on-board network)
35 bus bar of the on-board network for the auxiliary drives (3AC 400V-on-board network)
36 upper frame
37 lower frame
38 lifting mechanism with hoists
39 chassis carriers
40 electrically driven wheels

What is claimed is:

1. A straddle carrier having an electric drive system comprising:
a lower frame consisting of chassis carriers having electrically driven wheels;
an upper frame connected with the upper frame by means of supports;
a lifting mechanism with hoists disposed on the upper frame;
a power generation unit that feeds its generated electric power into a direct voltage intermediate circuit, to which current inverters for supplying travel, lifting, and auxiliary motors are connected, the power generation unit representing a micro gas turbine having an attached power generator, the power of which is passed to the travel, lifting, and auxiliary motors;
a separate regulator disposed on the micro gas turbine, said regulator regulating operating variables of power, speed of rotation, and temperature of the turbine individually, together, or in combination, to achieve reference values that can be predetermined;
current inverters that can be regulated, said inverters being disposed ahead of the chassis, auxiliary, and lifting mechanism motors;
an electronic power management of the straddle carrier disposed on the regulator for the power generation unit, said power management coordinating power and voltage of the power generation unit and drive motors with one another, wherein appropriate reference values are provided to the regulator of the power generation unit and the current inverters of the drive motors which can be regulated by the power management, wherein the most different load demands of travel and lifting mechanism drives occur superimposed on one another; and
an electric power storage unit disposed on a bus bar of the intermediate circuit, directly or indirectly, which unit evens out load variations and saves braking and lowering power.

2. A straddle carrier according to claim 1, wherein the micro gas turbine is air-mounted.

3. A straddle carrier according to claim 1, wherein the micro gas turbine and the generator are air-cooled.

4. A straddle carrier according to claim 1, wherein the generator represents a permanently excited electric rotary current machine.

5. A straddle carrier according to claim 1, wherein the power generator feeds its current directly into a bus bar of the direct voltage intermediate circuit of the straddle carrier, by way of a controllable current inverter.

6. A straddle carrier according to claim 5, wherein the current inverters represent direct current to rotary current inverters (DC/3AC).

7. A straddle carrier according to claim 5, wherein a starter battery is disposed on the bus bar of the intermediate circuit, said battery adapted to start the turbine, wherein a feed current inverter of the power generation unit drives the generator by motor, until the turbine fires.

8. A straddle carrier according to claim 7, further comprising a charge/discharge regulator disposed on the starter battery.

9. A straddle carrier according to claim 1, wherein the power storage unit is a traction battery or a double-layer capacitor.

10. A straddle carrier according to claim 9, wherein a double-layer capacitor and a battery are used as the power storage unit.

11. A straddle carrier according to claim 1, further comprising a heat exchanger disposed on the micro gas turbine.
